(19) United States
(12) Patent Application Publication
(10) Pub. No.: US 2006/0202056 A1
(43) Pub. Date: Sep. 14, 2006

(54) Roller

(76) Inventor: John Hancock, Hitchin (GB)

Correspondence Address: DAVID A. GUERRA;INTERNATION PATENT GROUP, LLC, 10TH FLOOR, 610 8TH AVENUE S.W., CALGARY, AB, T2P 1G5, CA

(21) Appl. No.: 10/565,167

(22) PCT Filed: Jul. 21, 2004
(86) PCT No.: PCT/GB04/03167

§ 371 Date: Jan. 19, 2006

(30) Foreign Application Priority Data
Jul. 21, 2003 (GB) 0317019.8

(51) Int. Cl. B05B 9/04; B05B 9/00

(52) U.S. Cl. 239/147; 239/373; 239/333

(57) ABSTRACT

A roller comprising a substantially cylindrical body (2) and a handle (3) pivotably attached to the body, the body (2) comprising a chamber (8) for containing a liquid, an outlet (16) in fluid communication with the chamber (8) and pump means (11) for dispensing a liquid from the chamber (2) through the outlet. The handle (3) may be detached from the body (2) of the roller and may house a hose. The roller may be used for multiple functions including a spray, a lawn aerator and lawn edger.

### CROSS-REFERENCE TO RELATED APPLICATIONS

This application is an U.S. national phase application under 35 U.S.C. §371 based upon co-pending International Application No. PCT/GB2004/003167 filed Jul. 21, 2004. Additionally, this U.S. national phase application claims the benefit of priority of co-pending International Application No. PCT/GB2004/003167 filed Jul. 21, 2004, and United Kingdom Application No. GB 0317019.8 filed Jul. 21, 2003. The entire disclosures of the prior applications are incorporated herein by reference. The international application was published in the English language on Feb. 10, 2005 under Publication No. WO 2005/011356 A1.

### BACKGROUND OF THE INVENTION

1. Field of the Invention

A ROLLER THE PRESENT INVENTION relates to a roller, and more particularly to a roller capable of storing and dispensing a liquid.

2. Description of Related Art

Rollers have many uses and are often used to smooth or flatten areas such as a lawn. In order to effectively smooth or flatten the ground, such a roller must be of substantial weight. In addition to rollers of fixed weight, rollers have been proposed which may be filled with a liquid such as water in order to increase their effective weight.

In addition, it have been previously proposed to use such a water-filled roller as a container or reservoir of water to be transported to a particular location for dispensing the water. However, such proposed rollers often required external pumping means and other apparatus in order to be used in this way.

There have also been proposed sprayers for use around gardens. However, these are often bulky and weighty items which are not easily transported to desired locations.

It can be appreciated that there exist disadvantages with existing devices such as those discussed above.

### BRIEF SUMMARY OF THE INVENTION

The present invention seeks to provide an improved roller.

According to one aspect of the present invention, there is provided a roller comprising a substantially cylindrical body and a handle pivotably attached to the body, the body comprising a chamber for containing a liquid, an outlet in fluid communication with the chamber and pump means for dispensing a liquid from the chamber through the outlet.

Preferably, the handle is detachable from the body.

Conveniently, the handle is attached to one end of the body.

Advantageously, one end of the roller is detachable.

Preferably, the detachable end cap comprises a handle portion.

Conveniently, the body comprises a central shaft.

Advantageously, the roller comprises means for compressing material stored within the chamber.

Preferably, the pump means extend through one end of the body substantially along the axis of the body.

Conveniently, the body comprises a second chamber located within the first chamber.

Advantageously, the roller further comprises a hose which may be stored within the handle.

Preferably, the roller further comprises a plurality of spikes provided on the outer surface of the above.

Conveniently, the roller further comprises edging means attached to one end cap.

### BRIEF DESCRIPTION OF THE SEVERAL VIEWS OF THE DRAWINGS

The present invention will now be described, by way of example, with reference to the accompanying drawings in which:

FIG. 1 is a perspective view of a roller of the invention;

FIG. 2 is a cross-sectional view of the roller shown in FIG. 1;

FIG. 3 is a further perspective view of the roller shown in FIG. 1;

FIG. 4 is a partial perspective view of the handle 3 prior to attachment to the body 2;

FIG. 5 is an exploded view of the handle 3 and body 2 shown in FIG. 4;

FIG. 6 is a partial cross-sectional view of the attachment of the handle 3 to the body 2;

FIG. 7 is a perspective view of a roller fitted with a compression disc;

FIG. 8 is a cross-sectional view of the roller shown in FIG. 7;

FIG. 9 is a perspective view of the roller fitted with a small chamber;

FIG. 10 is a cross-sectional view of a roller shown in FIG. 9;

FIG. 11 is a perspective view of a roller fitted with aerating spikes;

FIG. 12 is a cross-sectional view of the roller shown in FIG. 11;

FIG. 13 is a perspective view of a roller fitted with an edging blade;

FIG. 14 is a cross-sectional view of the roller shown in FIG. 13;

FIG. 15 is a side view of a roller fitter with an edging blade.

### DETAILED DESCRIPTION OF THE INVENTION

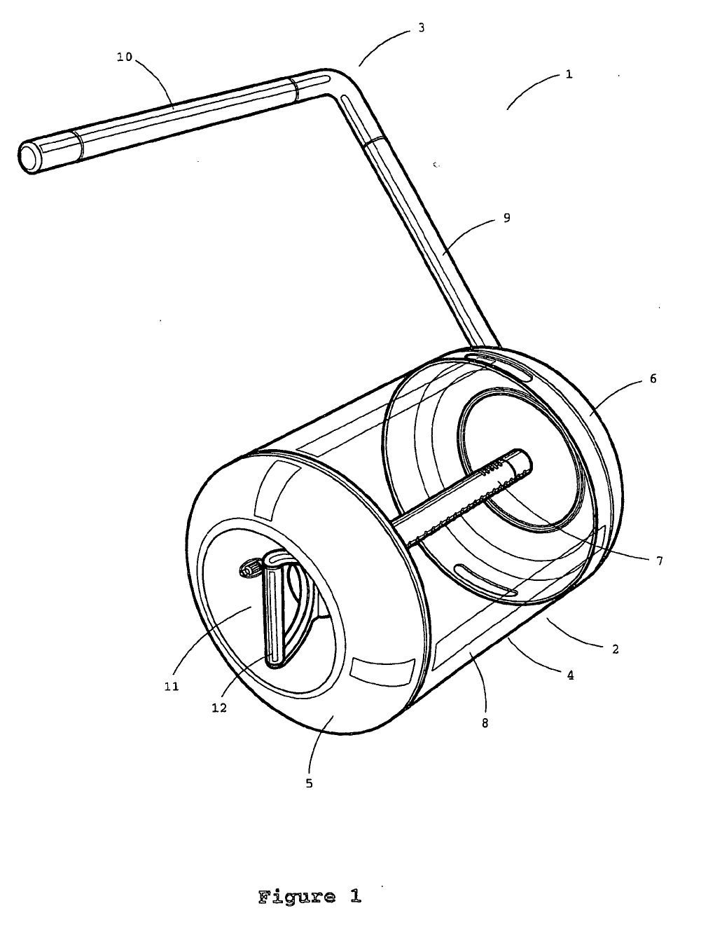

Turning to FIG. 1, a roller of the invention is shown generally at 1, comprising a substantially cylindrical body 2 and an attached handle 3. The body 2 comprises a tubular wall 4 which is connected to a first end cap 5 and a second end cap 6. The tubular wall 4 is constructed from a semi-transparent plastic material. In an alternative embodiment, the wall 4 may be manufactured from metal. A shaft 7 runs substantially along the axis of body 2 and connects the first end cap 5 to the second end cap 6.

The body 2 thus comprises a chamber 8 bounded by the tubular wall 4 and the first end cap 5 and the second end cap 6.

The handle 3 is substantially L-shaped and is releasably attached to the body 2 at a point substantially centrally located on the second end cap 6.

The handle 3 is capable of pivoting about the connection to the end cap 6, thus allowing the body to be rolled over the ground whilst pivoting about the connection with the handle 3.

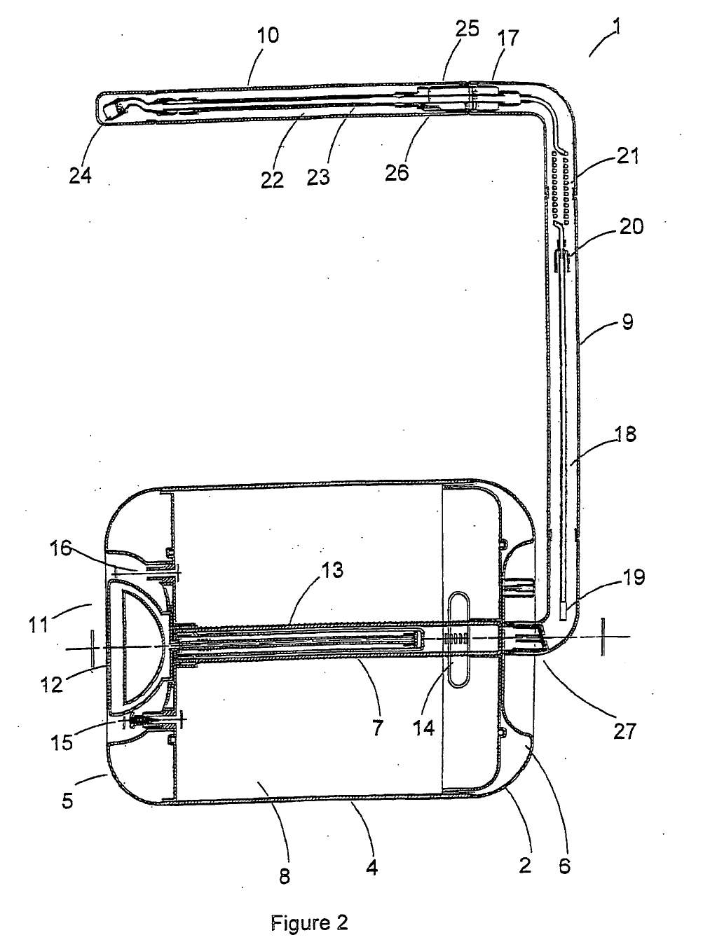

As shown in FIGS. 1 and 2, the handle 3 comprises three portions. The first portion 27 attaches the handle 3 to the body 2 and is discussed in more detail below.

When the handle 3 is attached to the body 2, the first portion 27 extends from a socket 28 in the second end cap 6, substantially along the axis of the body 2 for a short distance away from the second end cap 6. From this end of the first portion 27 of the handle 3 the second portion 9 extends substantially perpendicularly away from the first portion 27, i.e. in a direction radially away from the axis of the body 2, for a distance which is slightly longer than the overall length of the body 2. The third portion 10 of the handle 3 extends substantially perpendicularly away from the end of the second portion 9, in a direction substantially coaxial with the axis of the body 2. The third portion 10 extends for a distance slightly longer than the length of body 2. The handle 3 may be taken apart into several separate pieces for convenient storage within the body 2 when not in use. In use, a user may grasp the third portion 10 of the handle 3 in order to trundle the body 2 along the ground.

The body 2 is provided with a pump 11, the operation of which will be discussed in detail below. Briefly, the pump 11 comprises a handle 12 located externally of the chamber 8 and which extends through the first end cap 5 into a pump mechanism 13 located within the shaft 7.

Turning to FIG. 2, a cross-section of the roller 1 along the plane defined by the handle 3 and the central shaft 7 is shown.

The pump 11 comprises the external handle 12 which is connected to the pump mechanism 13 positioned within the hollow shaft 7. The pump mechanism 13 is shorter than the shaft 7 giving a free volume within the end of shaft 7. This area of the shaft 7 is provided with a series of apertures 14 which provide fluid communication between the volume within the shaft 7 and the chamber 8. In use, the handle 12 is pushed towards the body 2 and twisted anticlockwise to unlock it from a locked state. The pump handle 12 may then be moved repeatedly away from and towards the body 2 in order to pump air through the pump mechanism 13 into the free space at the end of the shaft 7, through the apertures 14 and into the chamber 8. The pump 11 may thus be used to pressurise the contents of the chamber 8. For safety purposes there is a pressure valve 15 which releases excess pressure if the chamber 8 is pressurised above a pre-determined level, such as 45 psi (3 bar). The pressure valve 15 is located in the first end cap 5. There is also provided an outlet 16 in the first end cap 5 which allows fluid to be dispensed from the chamber 8. The pump 11 is located centrally through an aperture in the first end cap 5 and the valve 15 and outlet 16 are located diametrically about the pump 11.

A spray 17 may be connected to the outlet 16 for convenient dispensing of a liquid from within the chamber 8. As shown, the various components of the spray 17 may be conveniently stored within the handle 3. To retrieve the spray 17 from this stored state, the third portion 10 may be removed from the remainder of the handle 3 to expose the lance 21. The spray 17 may then be pulled out and the third portion 10 replaced on the remainder of the handle 3. This process may be reversed in order to store the spray 17 within the handle 3 after use.

The spray 17 comprises three major portions. The first portion is for insertion through the outlet 16 and into the chamber 8 and comprises an elongate tube 18 of plastic material which is provided with a weighted filter 19 at its free end. At the other end of the tube 18 there is provided attachment means 20 which engages with the outlet 16 in a liquid-tight manner. In use, the tube 18 is inserted through the outlet 16 into the chamber 8 and is attached by screwing the attachment means 19 onto the outlet 16. The weighted filter 19 ensures that the open end of the tube 18 is located towards the bottom of the chamber 8, with the filter preventing particulate matter from passing into the tube 18 and blocking the spray 17.

The second portion of the spray 17 is a length of flexible plastic hose 21 which is stored in a coiled state when the spray 17 is located within the handle 3. The hose 21 is connected to the tube 18 through the attachment means 20. The hose 21 leads to the third portion of the spray 17 which is a lance 22. The lance 22 comprises a telescopic section 23 leading to an adjustable spray head 24. The lance 22 comprises two trigger switches 25 and 26 which control the flow of liquid through the spray 17. The first trigger 25 allows fluid to flow through the spray 17 only whilst being depressed by the user and automatically shuts off the flow of fluid when pressure on the trigger 25 is released. In contrast, the second trigger 26 may be toggled between an open position, allowing fluid flow through the spray 17, and a closed position. The user may toggle this switch 24 into the open position to allow fluid flow without having to continually depress the switch.

In order to use the roller 1 as a liquid dispensing device, the handle 12 of the pump 11 is twisted anticlockwise without initially depressing the handle in order to unscrew and detach the whole pump means 11 from the body 2. Liquid may then be conveniently poured through the opening left by the removal of the pump 11 into the hollow shaft 7 and then through the apertures 14 into the chamber 8. Once a sufficient level of liquid has been reached, the pump 11 is then reinserted into the aperture in the first end cap 5 of the body 2. The handle 12 is then depressed and turned anticlockwise in order to release it for pumping.

Repeated reciprocal movement of the handle 12 forces air into the chamber 8 as described above. This pressurises the contents of chamber 8 ready for dispensing the liquid. The spray 17 may then be used by depressing one of the triggers 25 and 26 to allow pressurised liquid inside the chamber 8 to be expelled through tube 18 via outlet 16 along the spray 17 and out of the spray head 24. Once the chamber 8 is emptied of liquid, or if no more liquid needs to be dispensed, the pressure valve may be activated to release excess pressure. The pump 11 may then be removed in order to empty any remaining liquid from the chamber 8. The spray 17 may be removed from the outlet 16 and replaced within the handle 3.

In addition to dispensing water, the roller 1 may also be used to transport and dispense other liquids, such a pesticides, herbicides or fertilisers, and also liquids such as wood/shed treatments such as water-proofing agents or preservatives.

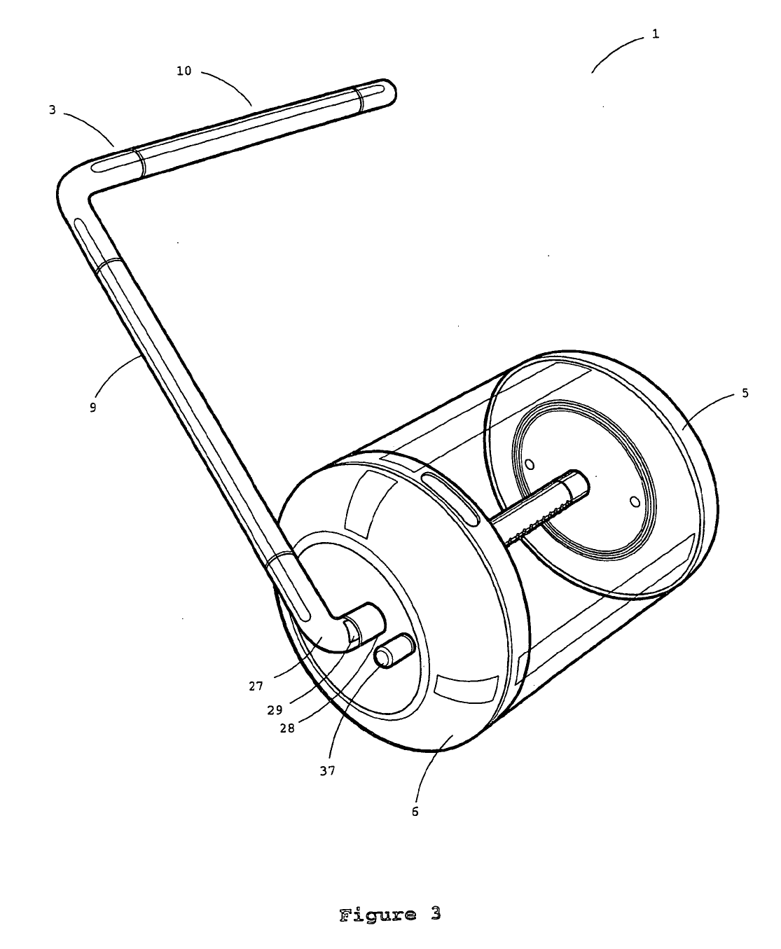

The handle 3 may be reversibly detached from the body 2 as described below with reference to FIGS. 3,4, 5 and 6. As FIG. 3 shows, the first portion 27 may be received within a socket 28 located centrally on the external face of the second end cap 6. On the external face of the second end cap 6 there is also provided a handle 37, the purpose of which will be discussed below.

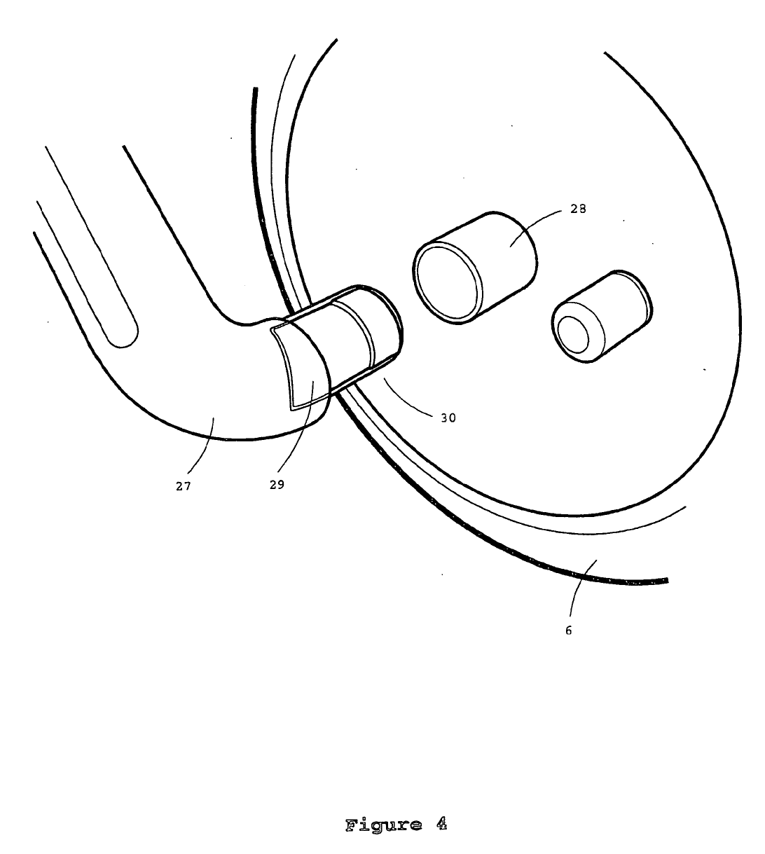

As shown in FIG. 4, the first portion 27 of the handle 3 comprises a locking mechanism 30 which allows the handle to be securely attached to the body 2 and which permits easy detachment of the handle 3 by the user. As described below, the handle 3 may be removed from the body 2 by depression of a pair of buttons 28 located on the first portion 27.

FIG. 4 shows the first portion 27 of the handle 3 removed from the socket 28 of the body 2. The locking mechanism 30 extends from the end of the first portion 27 and is adapted to be received within the socket 28.

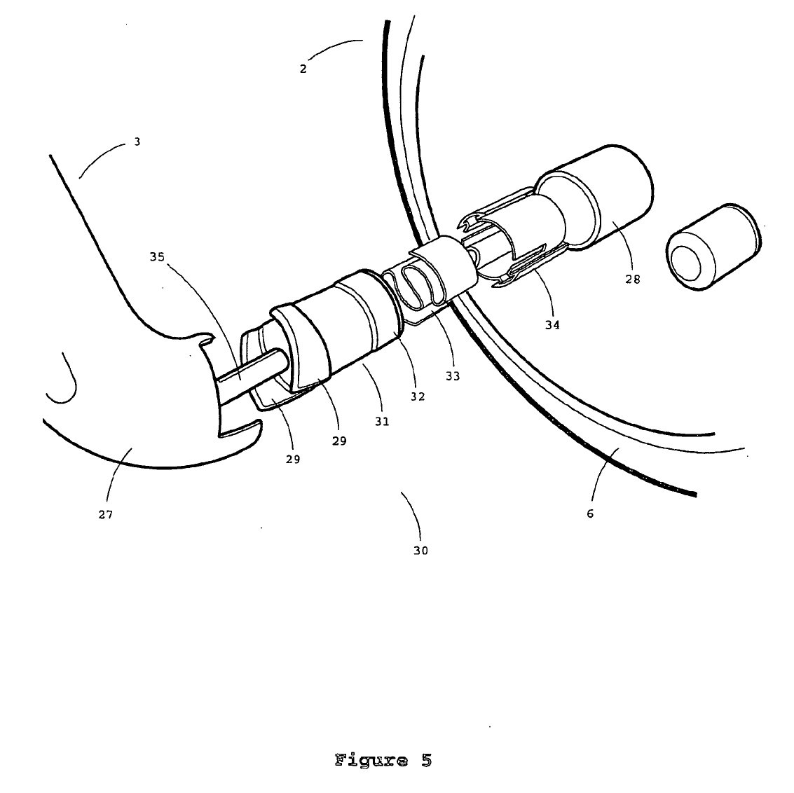

FIG. 5 shows the components of the locking mechanism 30 in an exploded state for clarity. The mechanism 30 comprises three components 31,33 and 34 which are mounted on a shaft 35 which extends from the end of the first portion 27 of the handle 3. The first portion 31 of the locking mechanism 30 comprises a circular end wall from which projects two shaped fingers in a direction substantially orthogonal to the plane of the circular wall. The fingers project from diametrically opposite peripheral portions of the circular end wall. The fingers are shaped to form two locking portions 32 proximal the circular end wall and the two release buttons 29 distal the circular end wall. By moving the release buttons 29 towards each other, the whole component 31 flexes, bringing the locking portions 32 towards each other.

The second portion 33 of the mechanism 30 is a compression spring, which is adapted to be received within the third portion 34 of the mechanism 30. The portion 34 has a substantially cylindrical shape with notches adapted to receive the spring 33. Spring 33 is received within portion 34 which in turn is received within portion 31, all of which is mounted on shaft 35 extending from the end of the first portion 27 of handle 3. The three components of the locking mechanism 30 provide a resilient bias to maintain or return the locking portions 32 to their normal radially extended positions.

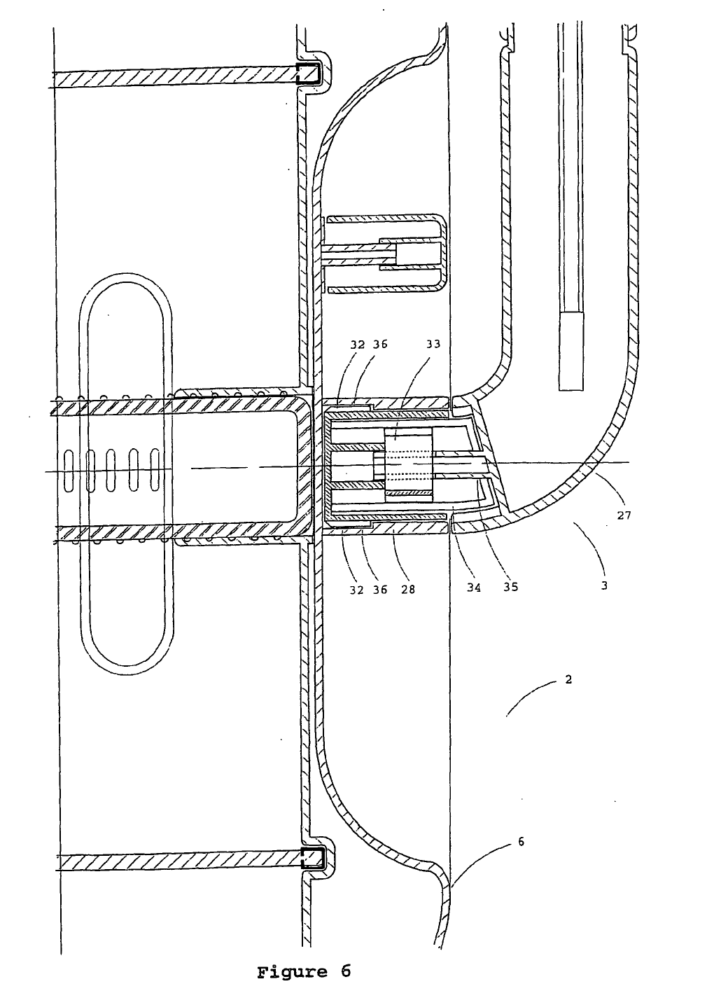

The locking portions 32 have a chamfered edge proximal the circular end wall to facilitate the easy insertion of the mechanism 30 into the socket 28. FIG. 6 shows the situation once the handle 3 is attached to the body 2. The interior of the socket 28 has a section 36 of increased diameter positioned away from its entrance. The section 36 is adapted to receive the locking portions 32 of the mechanism 30. As the mechanism 30 is inserted into the socket, the locking portions 32 are compressed towards each other allowing the mechanism 30 to be fully inserted into the socket 28. Once the locking portions 32 reach the section 36, they expand to their normal radially extended positions, allowing secure abutment of their surfaces with the surfaces of section 36. This ensures a tight fit between the handle 3 and the body 2.

To remove the handle 3, the user clutches and squeezes the release buttons 29 towards each other. This flexes the mechanism 30, bringing the locking portions 32 towards each other, allowing the mechanism 30 to be withdrawn from the socket 28.

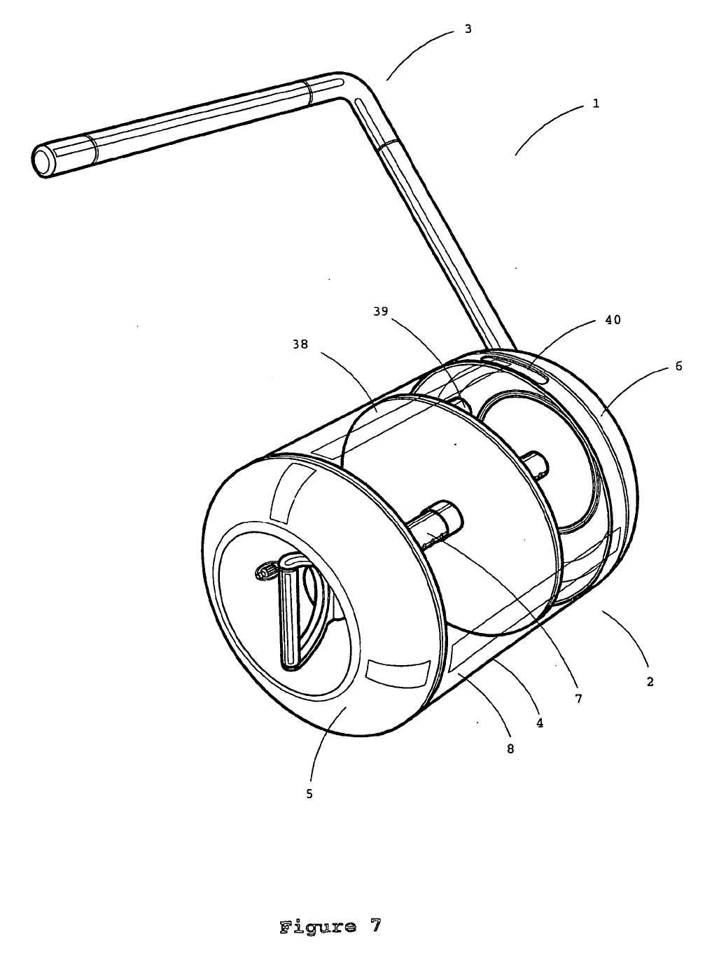

FIG. 7 shows a further use of the roller 1 of the invention as a container for other materials, such as garden waste.

As discussed above, the body 2 comprises a tubular wall 4 capped by a first end cap 5 and a second end cap 6 which are connected together via a shaft 7 running substantially along the axis of the body 2. The second end cap 6 may be unscrewed from the shaft 7 and removed from the body 2. This may be achieved by removing the handle 3 from the second end cap 6 as described above, and then unscrewing the end cap 6 from the shaft 7 by turning the handle 37. The walls of the second end cap 6 are provided with apertures 40 for its use as a container. Once removed from the body 2, the end cap 6 may be carried around by the apertures 40 and used as a receptacle for various objects and material. The compression disk 38, which will be described below, can serve as a lid for the end cap 6 when removed from the roller 1.

Removal of the second end cap 6 leaves a large aperture at the end of the body 2 which allows material to be placed into the chamber 8. This material may comprise grass cuttings or other garden refuse. Such material tends to be bulky with a relatively low density. The body 2 may thus be used as a storage or transporting container for such material. In order to make efficient use of the chamber 8, material may be placed into the chamber 8 and then compressed, allowing more material to be added. This is achieved by screwing a compression disk 38 onto the threaded shaft 7. The compression disk 38 is of substantially planar configuration having a central aperture adapted to receive the screw-threaded shaft 7. Towards the periphery of one face of the compression disk 38 there is located a handle 39 for turning the disk about the shaft 7 in order to move the disk 38 along the shaft 7 as desired. Turning the disk by use of the handle 39 allows the disk to be moved towards the first end cap 5, thus effectively compressing the waste. The disk may then be unscrewed from the shaft 7 in order to allow more material to be added. In an alternative embodiment, the compression disk 38 may be adapted to be released from the screw thread of shaft 7 in order to rapidly slide the disk 38 to a desired location before engaging with the screw thread.

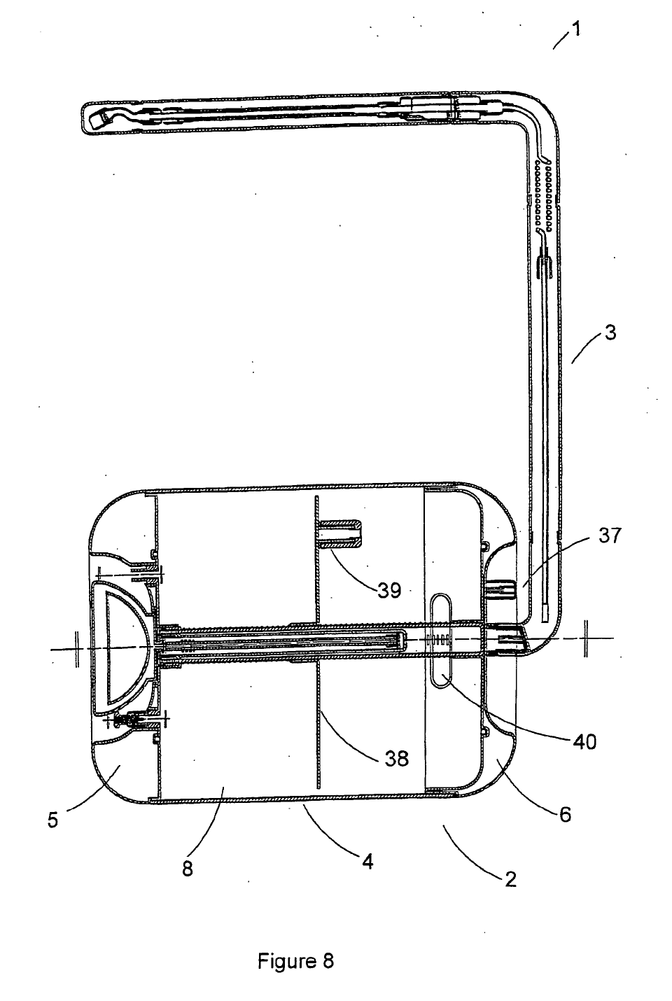

FIG. 8 is a cross-sectional view corresponding to FIG. 7 along the plane defined by the handle 3 and the shaft 7. The arrangement of the compression disk 38 on the shaft 7 can easily be seen.

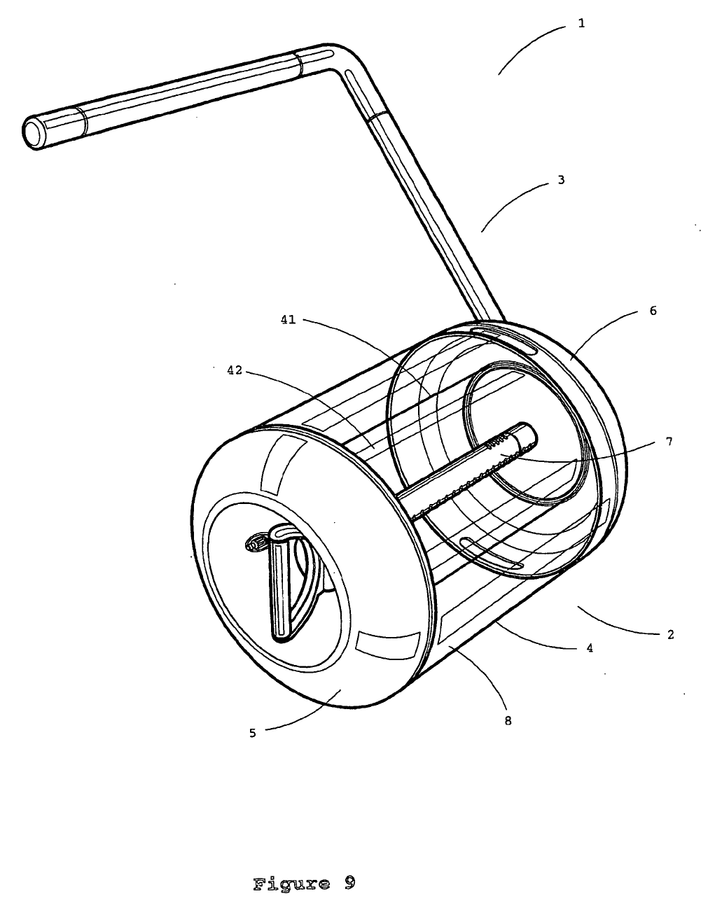

As mentioned above, the chamber 8 defines a volume of around 100 litres. In many instances, it would be preferable to have a chamber of smaller volume, for example of around 30 litres. As illustrated in FIG. 9, this can be achieved by the use of second tubular wall 41. The second end cap 6 may be unscrewed from the shaft 7 to allow the second tubular wall 41 to be inserted into the body 2, and arranged substantially concentric with the tubular wall 4, coaxial with the shaft 7. The second end cap 6 may then be screwed back onto the shaft 7. The ends of the second tubular wall 41 are then pressed against the internal surfaces of the first and second end caps in a liquid type manner. This is achieved by a first circular seal 43 and a second circular seal 44 on the first end cap 5 and second end cap 6 respectively. Screwing the second end cap 6 onto the shaft 7 ensures that the second tubular wall 41 is seated against the first and second seals 43 and 44 in a liquid type manner.

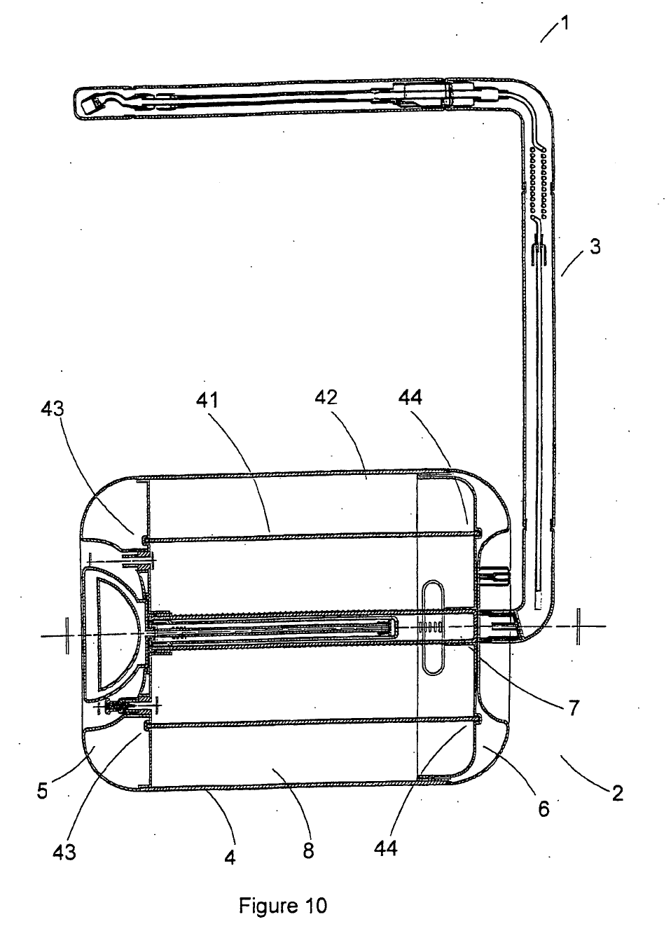

The volume within the second tubular wall 41 and the first and second end caps 5 and 6 thus defines a second chamber 42 of around 30 litres. As shown in FIG. 10, the second tubular wall 41 is located radially beyond the outlet 16 and the pressure valve 15, located in the first end cap 5. The pump 11 may be used to pressurise the second chamber 42 and its contents whilst still allowing use of the pressure valve 15 and the outlet 16. The spray 17 may be connected to the body 2 via the outlet 16 in the manner described above.

In addition to using the second chamber 42 as a pressurised container for liquid, it may also be used to contain a smaller volume of liquid that the first chamber 8 for use as a “rolling” weight only. This has advantages in preventing “sloshing” of a small amount of liquid in the larger first chamber 8 and also in that fewer pumps of the pump mechanism are needed to pressurise a smaller volume of liquid.

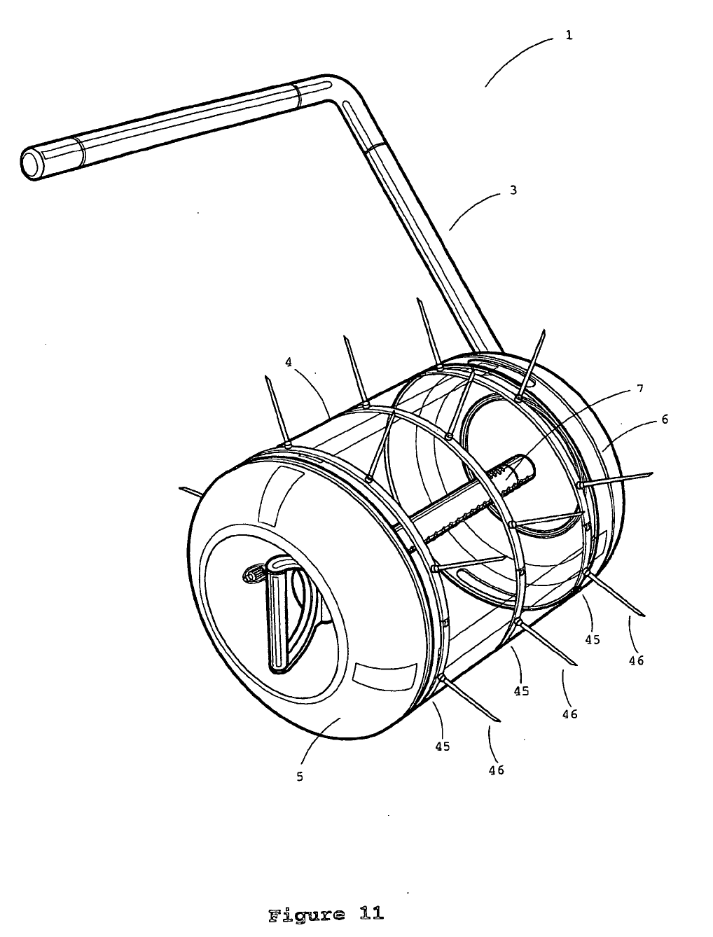

Aeration of ground may be performed to enhance and improve its properties. This may be done by inserting hollow spikes or tines into the ground in order to reduce compaction. The use of the roller 1 as an aerator is demonstrated in FIG. 11. The body 2 of the roller 1 is provided with three circumferential hoops 45 each provided with a plurality of radially projecting spikes 46. The hoops 45 each comprise a plurality of arcuate segments which may be placed around the external surface of the tubular wall 4 and connected together to give a complete hoop 45. The spikes 46 extend radially outwards from the hoops 31. In alternative embodiments, the spikes 46 may be shorter and/or hollow.

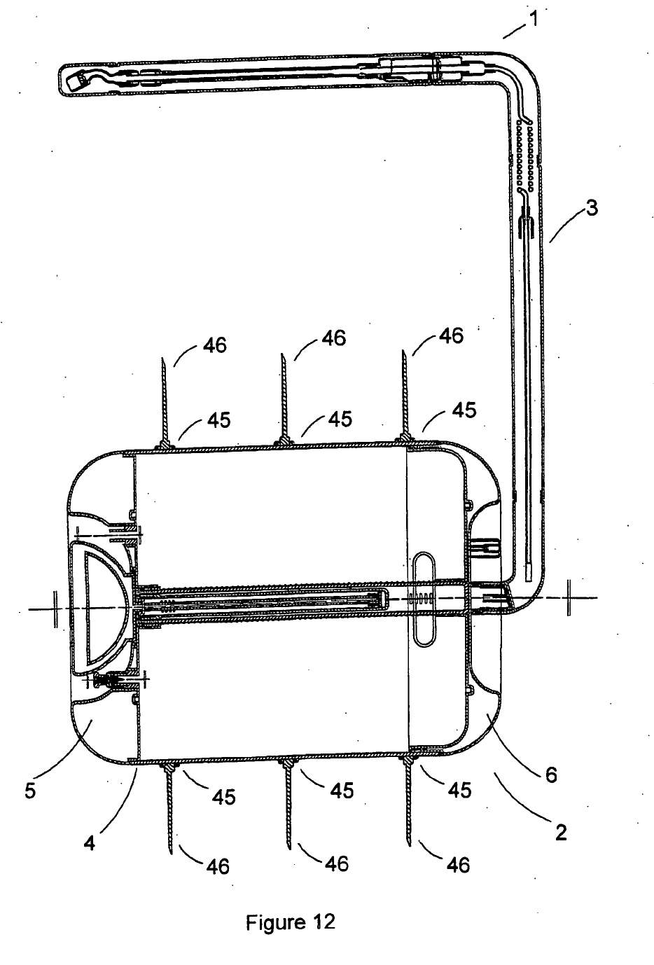

FIG. 12 is a cross-sectional view of the roller 1 shown in FIG. 11 along the plan defined by the handle 3 and the shaft 7. The roller 1 may be trundled along the ground with the spikes 46 being brought into contact with the ground as the body 2 rolls along. The chamber 8 or the second chamber 42 may be filled with liquid in order to ease the insertion of the spikes 46 into the ground.

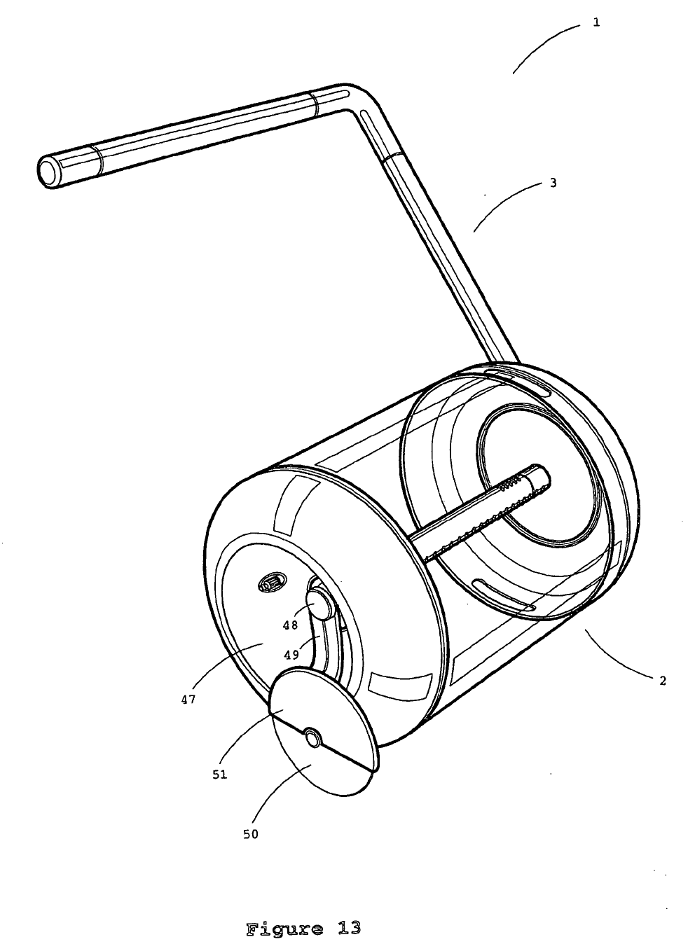

A further use of the roller 1 is shown in FIGS. 13,14 and 15. In this use, the pump 11 has been removed from the first end cap 5 and an edger 47 inserted in its place. The edger 47 comprises attachment means 48 which is inserted into the central aperture in the first end cap 5 left by removal of the pump 11. An arcuate arm 49 leads from the attachment means 48 to a position axially beyond the first end cap 5. A circular blade 50 is pivotally attached to the end of the arm 49. The blade 50 is provided with a shield 51 which covers the upper half of the blade 50. The position of the blade 50 relative to the body 2 may be adjusted to suit the cutting required. The edger 47 is rotatably attached to the body 2 by the attachment means 48.

In use, the roller 1 may be trundled along the ground with the blade 50 adjusted in order to cut the edge of a lawn.

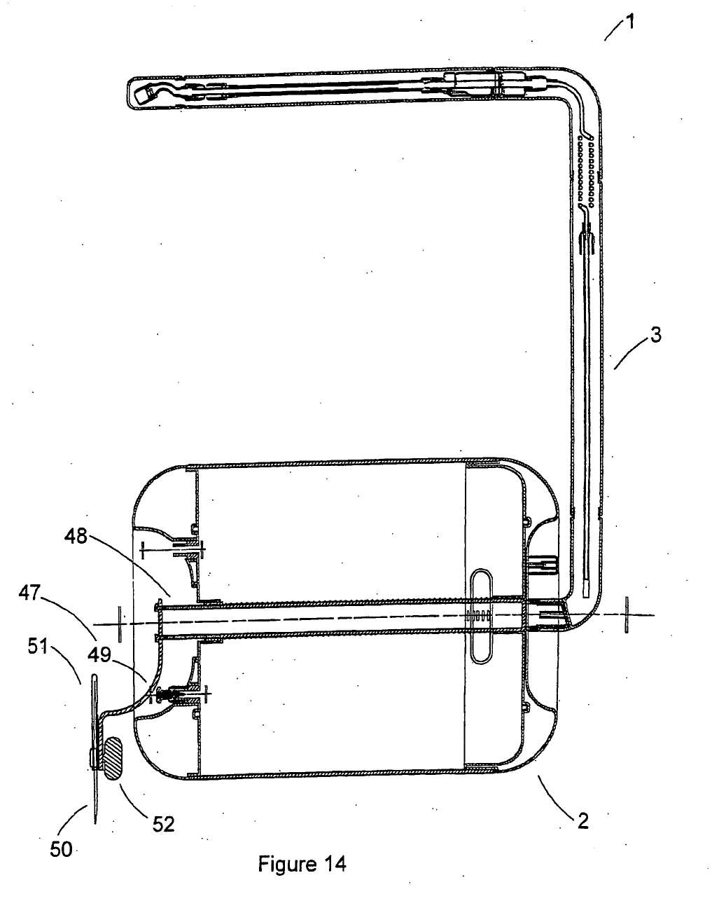

FIG. 14 is a cross-sectional view of the roller shown in FIG. 13 along the plane defined by the handle 3 and the shaft 7. A rotatable guide wheel 52 is provided at the end of arm 49, located on the opposite face of the arm 49 from the blade 50. The guide wheel 52 sits on the surface of the ground whilst blade 50 cuts into the ground.

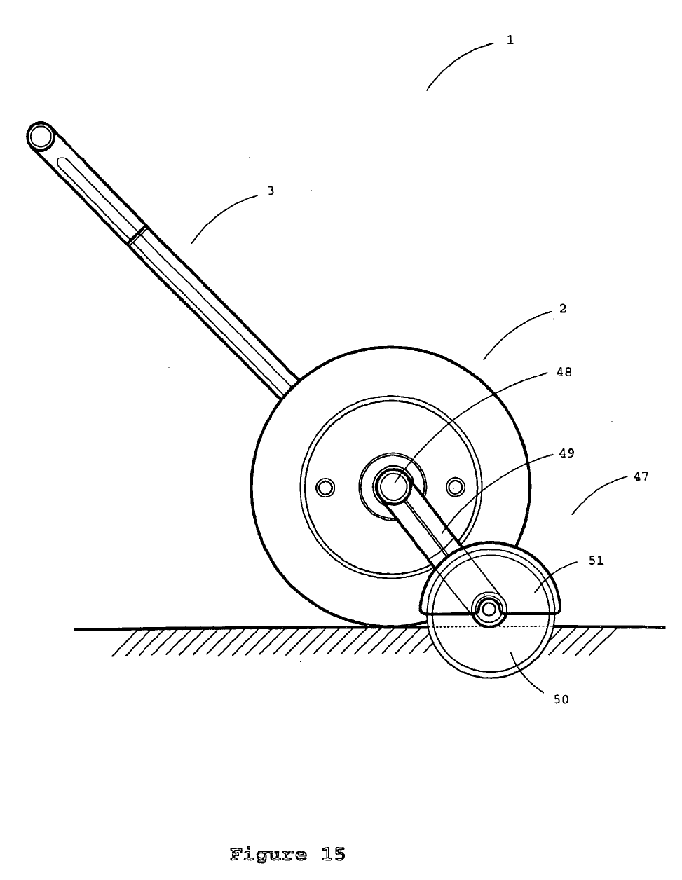

FIG. 15 shows the roller 1 and edger 47 in use being trundled along the ground. The blade 50 cuts into the ground ahead of the body 2 of the roller. The weight of the roller 2 (and liquid contained therein) and the force provided by the user pushing on the handle 3 ensure that the blade 50 cuts into the ground as shown. In alternative embodiments, the guide wheel 52 may be omitted, and/or the rotating blade 50 may be replaced with a nonrotating blade.

1-13. (canceled)

14. A roller system for storing and dispensing a liquid, said roller system comprising:
a substantially cylindrical body having a central shaft, a tubular wall, a first end cap, and a second end cap, said shaft running substantially along the axis of said body and removably connectable to said first end cap and to said second end cap, said tubular wall and said first and second end caps defining a chamber for containing a liquid;
a handle pivotably attachable to said second end cap of said body;
an outlet in fluid communication with said chamber; and
a pump means for dispensing the liquid from said chamber through said outlet.

15. The roller system as set forth in claim 14 further comprising a hose removably storable in said handle.

16. The roller system as set forth in claim 15 further comprising an elongate tube removably attachable to said hose, said elongate tube having a weighted filter at its free end and an outlet attachment means at the opposite end, said outlet attachment means is removably engagable with said outlet, said elongate tube being insertable through said outlet into said chamber.

17. The roller system as set forth in claim 16 further comprising a lance having a telescopic section leading to an adjustable spray head, and at least one switch for controlling the flow of liquid though said lance, said end opposite of said spray head being attachable to said hose.

18. The roller system as set forth in claim 14, wherein said pump means comprising a pump handle extending through said first end cap into a pump mechanism located within said shaft, wherein said first end cap being removably attachable to said tubular wall of said body.

19. The roller system as set forth in claim 18, wherein said pump mechanism being shorter than said shaft thereby defining a free volume area within the end of said shaft, said area of said shaft defining a series of apertures which provide fluid communication between said area within said shaft and said chamber of said body.

20. The roller system as set forth in claim 19 further comprising a pressure release valve located in said first end cap and in fluid communication with said chamber.

21. The roller system as set forth in claim 14 further comprising a second tubular wall insertable within said tubular wall of said body and removably attachable to said first and second end caps to define a second chamber in said chamber of said body.

22. The roller system as set forth in claim 14 further comprising a plurality of spikes removably attachable to said tubular wall of said body, said spikes extending outwardly from said body.

23. The roller system as set forth in claim 14 further comprising an edging means removably attached to said body.

24. The roller system as set forth in claim 14 further comprising a compression disk threadably attachable to said central shaft and adapted to be receivable within said tubular wall of said body.

25. The roller system as set forth in claim 14 further comprising a handle locking mechanism for removably and securely attaching said handle to said second end cap of said body, said locking mechanism comprising a first, second, and third portion all mountable to a shaft extending from the end of said handle, said first portion being receivable in a socket extending out from said second end cap, said second portion is a spring insertable in said third portion, said third portion being receivable in said first portion.

26. The roller system as set forth in claim 25, wherein said socket further comprising a section of increased diameter positioned away from the entrance of said socket, said increased diameter section being adapted to receive at least one locking portion positioned on said first portion when said first portion is inserted in said socket.

27. A roller system comprising:
a substantially cylindrical body having a central shaft, a tubular wall, a first end cap, and a second end cap, said shaft running substantially along the axis of said body and removably connectable to said first end cap and to said second end cap, said tubular wall and said first and second end caps defining a chamber for containing a liquid;
a handle pivotably attachable to said second end cap of said body;
an outlet in fluid communication with said chamber, said outlet being located on said first end cap;
a hose removably attachable to said outlet and adapted to be removably stored is said handle;
a manual pump for dispensing the liquid from said chamber through said outlet, said manual pump comprising a pump handle extending through said first end cap into a pump mechanism located within said shaft; and
wherein said pump mechanism being shorter than said shaft thereby defining a free volume area within the end of said shaft, said area of said shaft defining a series of apertures which provide fluid communication between said area within said shaft and said chamber of said body.

28. The roller system as set forth in claim 27 further comprising a handle locking mechanism for removably and securely attaching said handle to said second end cap of said body, said locking mechanism comprising a first, second, and third portion all mountable to a shaft extending from the end of said handle, said first portion being receivable in a socket extending out from said second end cap, said second portion is a spring insertable in said third portion, said third portion being receivable in said first portion.

29. The roller system as set forth in claim 28, wherein said socket further comprising a section of increased diameter positioned away from the entrance of said socket, said increased diameter section being adapted to receive at least one locking portion positioned on said first portion when said first portion is inserted in said socket.

30. The roller system as set forth in claim 29, wherein said third portion having a substantially cylindrical shape with defined notches adapted to receive said spring, said first, second, and third portions of said locking mechanism provide a resilient bias to said locking portion to a normal radially extended position.

31. The roller system as set forth in claim 27 further comprising a plurality of spikes removably attachable to said tubular wall of said body, said spikes extending outwardly from said body, and an edging means removably attached to first end cap of said body.

32. A roller system comprising:
a substantially cylindrical body having a central shaft, a tubular wall, a first end cap, and a second end cap, said shaft running substantially along the axis of said body and removably connectable to said first end cap and to said second end cap, said tubular wall and said first and second end caps defining a chamber for containing a liquid;
a handle pivotably attachable to said second end cap of said body;
a handle locking mechanism for removably and securely attaching said handle to said second end cap of said body, said locking mechanism comprising a first, second, and third portion all mountable to a shaft extending from the end of said handle, said first portion being receivable in a socket extending out from said second end cap, said second portion is a spring insertable in said third portion, said third portion being receivable in said first portion;
an outlet in fluid communication with said chamber, said outlet being located on said first end cap;
a hose removably attachable to said outlet and adapted to be removably stored is said handle;
an elongate tube removably attachable to said hose, said elongate tube having a weighted filter at its free end and an outlet attachment means at the opposite end, said outlet attachment means is removably engagable with said outlet, said elongate tube being insertable through said outlet into said chamber;
a lance having a telescopic section leading to an adjustable spray head, and at least one switch for controlling the flow of liquid though said lance, said end opposite of said spray head being attachable to said hose;
a manual pump for dispensing the liquid from said chamber through said outlet, said manual pump comprising a pump handle extending through said first end cap into a pump mechanism located within said shaft; and
wherein said socket further comprising a section of increased diameter positioned away from the entrance of said socket, said increased diameter section being adapted to receive at least one locking portion positioned on said first portion when said first portion is inserted in said socket.

33. The roller system as set forth in claim 32 further comprising a plurality of spikes removably attachable to said tubular wall of said body, said spikes extending outwardly from said body, and an edging means removably attached to first end cap of said body.
